(19) United States
(12) Patent Application Publication
(10) Pub. No.: US 2026/0353413 A1
(43) Pub. Date: Nov. 5, 2026

(54) RESOURCE RESERVATION AND RESOURCE SELECTION IN SIDELINK COMMUNICATION

(71) Applicant: TOYOTA JIDOSHA KABUSHIKI KAISHA, Toyota-shi, Aichi-ken (JP)

(72) Inventors: Takayuki SHIMIZU, Mountain View, CA (US); John KENNEY, Mountain View, CA (US); Hongsheng LU, Mountain View, CA (US); Onur ALTINTAS, Mountain View, CA (US); Chang-Yi LUO, Tokyo (JP); Nuno KIILERICH PRATAS, Gistrup (DK); Daniel MEDINA, Munchen (DE); Ling YU, Kauniainen (FI); Torsten WILDSCHEK, Gloucester (GB); Jun TAN, Glenview, IL (US)

(73) Assignee: TOYOTA JIDOSHA KABUSHIKI KAISHA, Toyota-shi, Aichi-ken (JP)

(21) Appl. No.: 19/116,462

(22) PCT Filed: Sep. 12, 2023
(86) PCT No.: PCT/JP2023/033218

§ 371 Date: Mar. 28, 2025

Related U.S. Application Data
(60) Provisional application No. 63/377,434, filed on Sep. 28, 2022.

(51) Int. Cl. H04W 72/25; H04W 28/26; H04W 72/02

(52) U.S. Cl. CPC H04W 72/25; H04W 28/26; H04W 72/02

(57) ABSTRACT

Disclosed are methods, apparatuses, and systems for resource selection in a sidelink communication. One of the methods includes: obtaining, by a first user equipment (UE) in the sidelink communication, resource reservation information of at least one of the first UE or a second UE, and at least one of: future beam information of at least one of the first UE or the second UE, or future location information of at least one of the first UE or the second UE; and transmitting, to one or more other UEs in the sidelink communication including the second UE, the resource reservation information of at least one of the first UE or the second UE, and the at least one of: the future beam information of at least one of the first UE or the second UE, or the future location information of at least one of the first UE or the second UE.

### CROSS-REFERENCE TO RELATED PATENT APPLICATION

This application claims the benefit of U.S. Provisional Application No. 63/377,434, filed on Sep. 28, 2022, entitled “RESOURCE RESERVATION SUITABLE FOR BEAM-BASED SIDELINK COMMUNICATION FOR BETTER SPATIAL REUSE,” the entirety of which is incorporated by reference herein.

### TECHNICAL FIELD

Apparatuses and methods consistent with the present disclosure relate generally to communications, more specifically, methods, systems, and devices for resource reservation and resource selection in a sidelink communication.

### BACKGROUND ART

Sidelink communication technology enables direct communication between two or more devices, for example, two or more vehicles in a vehicle-to-everything (V2X) communication. A first vehicle in a sidelink communication may provide its resource reservation information to one or more other vehicles, for example, using a periodic broadcast of sidelink signal, so that other vehicles can avoid selecting the same resources for transmission. This scheme may work well for sidelink communications using low frequency bands (e.g., 5.9 GHz or lower). But resource reservation and resource selection for sidelink communications using high frequency bands (e.g., mmWave bands) may be more complicated. For high frequency radio signals, which suffer from high propagation loss, beamforming with narrow beams is generally used to compensate for the propagation loss. In this case, the resource reservation information of a first vehicle alone may not be sufficient for other vehicles to accurately and efficiently determine the resource to be selected or excluded. This is especially the case when the first vehicle and other vehicles are moving.

### SUMMARY OF INVENTION

According to some embodiments of the present disclosure, there is provided a first user equipment (UE) for providing information for resource selection in a sidelink communication. The first UE includes a memory storing an instruction; and a processor configured to execute the instruction stored in the memory to: obtain resource reservation information of at least one of the first UE or a second UE, and at least one of: future beam information of at least one of the first UE or the second UE, or future location information of at least one of the first UE or the second UE; and transmit, to one or more other UEs in the sidelink communication including the second UE, the resource reservation information of at least one of the first UE or the second UE, and the at least one of: the future beam information of at least one of the first UE or the second UE, or the future location information of at least one of the first UE or the second UE.

According to some embodiments of the present disclosure, there is provided an apparatus for obtaining information for resource selection in a sidelink communication. The apparatus includes a memory storing an instruction; and a processor configured to execute the instruction stored in the memory to: receive, from a first UE in the sidelink communication, resource reservation information of at least one of the first UE or a second UE, and at least one of: future beam information of at least one of the first UE or the second UE, or future location information of at least one of the first UE or the second UE; and select or re-select sidelink resources based on the received resource reservation information of at least one of the first UE or a second UE, and the at least one of: the future beam information of at least one of the first UE or the second UE, or the future location information of at least one of the first UE or the second UE.

According to some embodiments of the present disclosure, there is provided a method providing information for resource selection in a sidelink communication. The method includes obtaining, by a first UE in the sidelink communication, resource reservation information of at least one of the first UE or a second UE, and at least one of: future beam information of at least one of the first UE or the second UE, or future location information of at least one of the first UE or the second UE; and transmitting, to one or more other UEs in the sidelink communication including the second UE, the resource reservation information of at least one of the first UE or the second UE, and the at least one of: the future beam information of at least one of the first UE or the second UE, or the future location information of at least one of the first UE or the second UE.

According to some embodiments of the present disclosure, there is provided a method for obtaining information for resource selection in a sidelink communication. The method includes receiving, by an apparatus in the sidelink communication, from a first UE, resource reservation information of at least one of the first UE or a second UE, and at least one of: future beam information of at least one of the first UE or the second UE, and future location information of at least one of the first UE or the second UE; and selecting or re-selecting, by the apparatus, sidelink resources based on the received resource reservation information of at least one of the first UE or a second UE, and the at least one of: the future beam information of at least one of the first UE or the second UE, or the future location information of at least one of the first UE or the second UE.

According to some embodiments of the present disclosure, there is provided a non-transitory computer-readable medium storing instructions that are executable by one or more processors of a UE to perform a method. The method includes obtaining resource reservation information of at least one of the first UE or a second UE, and at least one of: future beam information of at least one of the first UE or the second UE, or future location information of at least one of the first UE or the second UE; and transmitting, to one or more other UEs in the sidelink communication including the second UE, the resource reservation information of at least one of the first UE or the second UE, and the at least one of: the future beam information of at least one of the first UE or the second UE, or the future location information of at least one of the first UE or the second UE.

According to some embodiments of the present disclosure, there is provided a non-transitory computer-readable medium storing instructions that are executable by one or more processors of an apparatus to perform a method. The method includes receiving, from a first UE in the sidelink communication, resource reservation information of at least one of the first UE or a second UE, and at least one of: future beam information of at least one of the first UE or the second UE, or future location information of at least one of the first UE or the second UE; and selecting or re-selecting sidelink resources based on the received resource reservation information of at least one of the first UE or a second UE, and the at least one of: the future beam information of at least one of the first UE or the second UE, or the future location information of at least one of the first UE or the second UE.

### BRIEF DESCRIPTION OF DRAWINGS

FIG. 1 is a flow chart illustrating a method for resource selection in a sidelink communication, consistent with some embodiments of the present disclosure.

FIG. 2A is a schematic diagram illustrating a resource candidate determination procedure according to the method of FIG. 1, consistent with some embodiments of the present disclosure.

FIG. 2B is a table showing a correspondence between sub-carrier spacing (SCS) and a subset of resources according to the method of FIG. 1, consistent with some embodiments of the present disclosure.

FIG. 3A is a schematic diagram illustrating a transmission of resource reservation information in a sidelink communication; and FIG. 3B is a schematic diagram illustrating a resource collision avoidance using the resource reservation information in the sidelink communication of FIG. 3A, consistent with some embodiments of the present disclosure.

FIG. 4 is a schematic diagram illustrating a sidelink beamforming in a communication system, consistent with some embodiments of the present disclosure.

FIG. 5A is a schematic diagram illustrating side information exchange in a low frequency sidelink communication; and FIG. 5B is a schematic diagram illustrating a side information assisted beam alignment in the sidelink communication, consistent with some embodiments of the present disclosure.

FIG. 6 is a schematic diagram illustrating resource reservation information for beam-based sidelink communication, consistent with some embodiments of the present disclosure.

FIG. 7 is a schematic diagram illustrating an exemplary resource collision avoidance system, consistent with some embodiments of the present disclosure.

FIG. 8 is a schematic diagram illustrating a method for indicating an estimated future location of a UE, consistent with some embodiments of the present disclosure.

FIG. 9A is a schematic diagram illustrating a method for indicating an estimated future beam information, and FIG. 9B is a schematic diagram illustrating another method for indicating an estimated future beam information, consistent with some embodiments of the present disclosure.

FIG. 10 is a flow chart illustrating a method for providing information for resource selection in a sidelink communication, consistent with some embodiments of the present disclosure.

FIG. 11 is a flow chart illustrating a method for obtaining information for resource selection in a sidelink communication, consistent with some embodiments of the present disclosure.

FIG. 12 is a block diagram of a UE, consistent with some embodiments of the present disclosure.

### DESCRIPTION OF EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

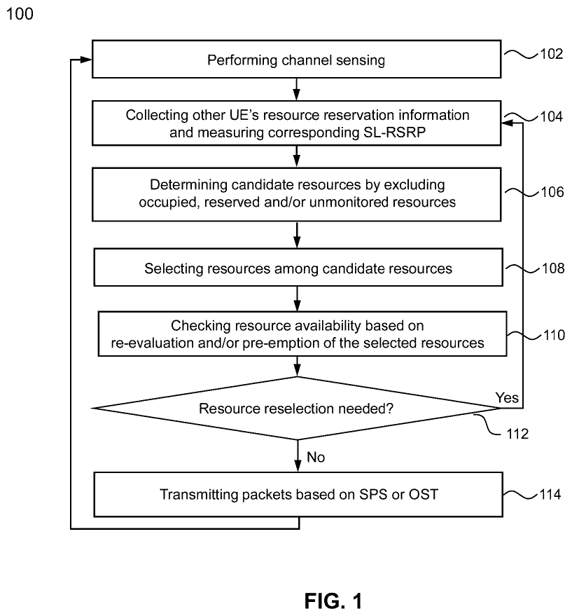

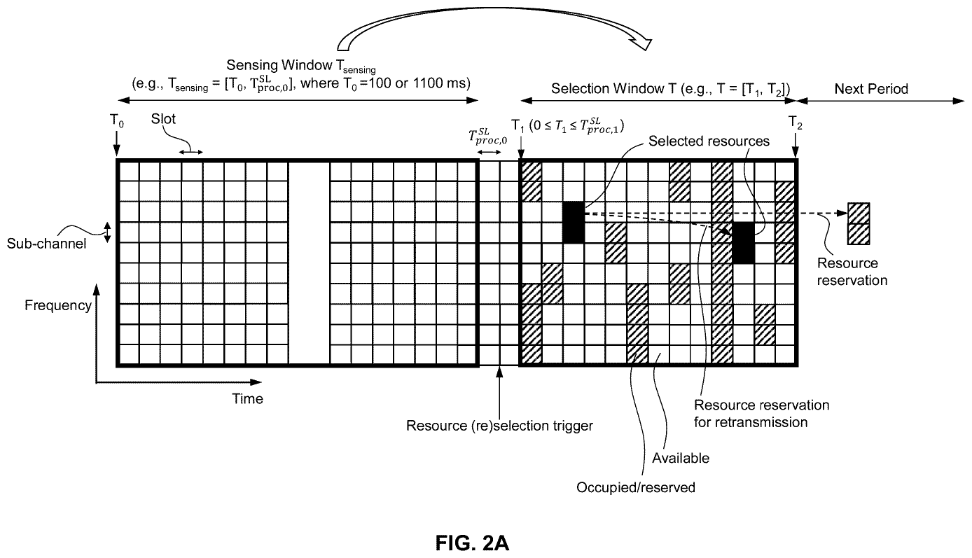

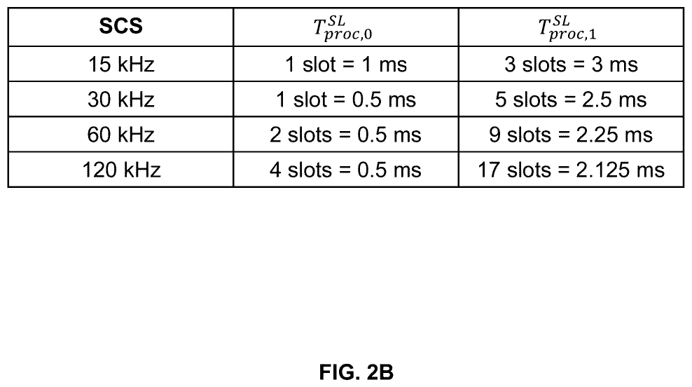

FIG. 1 is a flow chart illustrating a method 100 for resource selection in a sidelink communication; FIG. 2A is a schematic diagram illustrating a resource candidate determination procedure according to the method of FIG. 1; and FIG. 2B is a table showing a correspondence between SCS and a subset of resources according to the method of FIG. 1, consistent with some embodiments of the present disclosure. The method 100 may be performed by a UE in a sidelink communication. For example, the method 100 may be performed by a vehicle in a V2X communication. The method 100 may be performed under a mode that employs orthogonal frequency division multiplexing (OFDM) at the physical (PHY) layer for a sidelink communication. An example of the mode is the 3GPP Release 16/17 5G NR-V2X PC5 mode 2.

As shown in FIG. 2A, in the mode, the time-frequency radio resources are divided into slots in the time domain and sub-channels in the frequency domain. In an embodiment, the mode may support SCSs of 15*2^{μ} KHz, where μ is the OFDM numerology μ∈ {0, 1, 2, 3, 4}. For sub-6 GHZ frequency, SCSs of 15, 30, and 60 KHz (i.e., M={0, 1, 2}) may be supported, whereas for above 6 GHZ frequency, SCSs of 60, 120, and 240 KHz (i.e., μ∈{2, 3, 4}) may be supported. Each slot is ½^{μ} ms length and consists of 14 OFDM symbols. Each sub-channel may consist of multiple contiguous physical resource blocks (PRBs), where each PRB occupies 180*2^{μ} KHz and consists of 12 subcarriers with 15*2^{μ} kHz SCS. The size of sub-channel (i.e., the number of PRBs per sub-channel) is configurable or preconfigurable. To support multiple SCSs and different Doppler spreads, multiple demodulation reference signal (DMRS) density options (2~4 DMRS symbols per slot) are supported. Each UE may transmit a first stage SCI in the physical sidelink control channel (PSCCH) and data (e.g., transport block (TB) ), and a second stage sidelink control information (SCI) in the physical sidelink shared channel (PSSCH).

Hybrid automatic repeat request (HARQ) feedback (e.g., acknowledgement (ACK)/negative acknowledgement (NACK) or NACK only) may be transmitted in the physical sidelink feedback channel (PSFCH).

FIG. 2B shows the correspondence among SCS and parameters for the sensing window and selection window (T^{SL}_{proc,0} and T^{SL}_{proc,1}), consistent with some embodiments of the present disclosure. For example, when the SCS is 15 KHz, as shown in the second and third columns of FIG. 2B, T^{SL}_{proc,0} corresponds to 1 ms, and T^{SL}_{proc,1} correspond to 3 ms. As another example, when the SCS is 30 kHz, T^{SL}_{proc,0} corresponds to 0.5 ms, and T^{SL}_{proc,1} correspond 2.5 ms.

Referring back to FIG. 1, the method 100 includes a step 102 of performing a channel sensing (e.g., a background sensing or any other type of full sensing or partial sensing). For example, as shown in FIG. 2A, a UE may perform a channel sensing in a sensing window T_{sensing} (e.g., T_{sensing}=[T₀, T^{SL}_{proc,0}], Where T₀=100 or 1100 ms and T^{SL}_{proc,0} is given in FIG. 2B) to collect another UE's resource reservation information. The channel sensing with a sensing window of 100 ms may be for an aperiodic traffic, while the channel sensing with a sensing window of 1100 ms may be for a periodic traffic.

The method 100 includes a step 104 of collecting another UE's resource reservation information and measuring corresponding sidelink-reference signal received power (SL-RSRP). For example, as shown in FIG. 2A, the UE may perform a channel sensing in the sensing window and collect another UE's resource reservation information based on SCI decoding to identify candidate resources. In an embodiment, in order to perform the channel sensing and obtain information to receive other UEs' packets, the UE decodes SCI first. The SCI decoding may include two stages: a first stage SCI (SCI format 1-A) and a second stage SCI (SCI format 2-A or 2-B) as defined in 3GPP specifications. The first stage SCI may carry resource reservation information for future transmissions, information about resource allocation, modulation and coding scheme (MCS) for PSSCH, DMRS pattern, and the second stage SCI format, etc. The second stage SCI may carry control information for HARQ procedures, source/destination IDs, information for distance-based groupcast (e.g., UE's zone ID and communication range requirement), etc. Based on the resource reservation information contained in the first stage SCI, the UE may avoid using time and/or frequency resources reserved by other UEs when the UE performs resource selection or reselection.

The method 100 includes a step 106 of determining candidate resources by excluding occupied, reserved, and/or unmonitored resources. For example, the UE may exclude unmonitored slots from the selection window T (e.g., T=[T₁, T₂], where 0=<T₁=<T^{SL}_{proc,1} ms, T^{SL}_{proc,1} is given in FIG. 2B, and T₂ may be set based on the remaining packet delay budget). The UE may fail to sense the unmonitored slots in the sensing window due to, for example, its own transmission (e.g., half-duplex constraint). The UE may further exclude resources occupied or reserved by other UEs from the selection window if the corresponding SL-RSRP exceeds a configured or preconfigured SL-RSRP exclusion threshold. After resource exclusion, the number of candidate resources may be at least X% of the total number of resources in the selection window. Otherwise, the UE may increase the SL-RSRP exclusion threshold by, for example, 3 dB until at least X% resources are obtained, where X may be configured or preconfigured from {20, 35, 50}%.

The method 100 includes a step 108 of selecting resources among candidate resources. The selection may be a random selection. For example, as shown in FIG. 2A, the UE may Select resources among candidate resources in the selection window. The selected frequency resource can be used multiple times with a fixed time interval for semi-persistent scheduling (SPS) or only once for one-shot transmission (OST).

In some embodiments, the method 100 may utilize inter-UE coordination scheme in which one or more other UEs send coordination information about resources to the UE, and the UE utilizes that information for its resource selection or reselection. The inter-UE coordination scheme may include a first inter-UE coordination scheme and a second inter-UE coordination scheme. According to the first inter-UE coordination scheme, the UE may receive, from one or more other UEs, indications of resources that are preferred to be included in the UE's selected or reselected resources, or preferred to be excluded. In an embodiment, when an indication of resources indicates inclusion of given resources, the UE may solely rely on those resources, if the indication does not support sensing and/or resource exclusion. In an embodiment, the UE may also combine the indication of resources with resources identified by its own sensing procedure before making a final selection. The UE may receive the indication via medium access control (MAC) control element (CE) and/or 2nd-stage SCI. According to the second inter-UE coordination scheme, the UE may receive an indication that resources reserved for the UE's transmission will be, or could be, subject to conflict with a transmission from another UE. In this case, the UE may re-select new resources. The UE may receive the indication via PSFCH. The UE may use a mapping table that defines a mapping rule between PSSCH allocation (e.g., one or more slots and sub-channels) and PSFCH resources. Using the mapping table, the UE (and the transmitter UE) can determine the PSSCH allocation that the information in the PSFCH resource refers to. When more than one sub-channel is reserved in the PSSCH, multiple PSFCH resources may be used. The mapping table may be pre-defined, pre-configured at the UE, or configured by a network node.

The method 100 includes a step 110 of checking resource availability based on re-evaluation and/or pre-emption of the selected resources. This step may be performed for the late-arriving packets (e.g., aperiodic packets) after resource selection and before the packet transmission.

The method 100 includes a step 112 of determining whether a resource reselection is needed. If it is determined that a resource reselection is needed, the method may iterate from the step 104. On the other hand, if it is determined that a resource reselection is not needed, the method may proceed with a step 114 of transmitting packets based on SPS or OST. The packets may be initial packets or retransmitted packets. The UE may also retransmit packets multiple times (e.g., HARQ retransmissions) with or without feedback from receiver UEs to improve reliability of the transmission. After the step 114, the method 100 may reiterate from step 102.

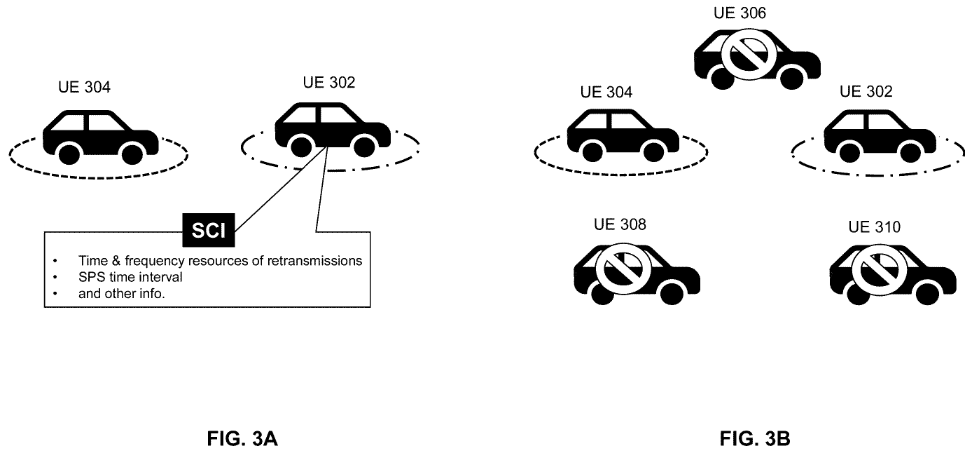

FIG. 3A is a schematic diagram illustrating a transmission of resource reservation information in a sidelink communication; and FIG. 3B is a schematic diagram illustrating a resource collision avoidance using the resource reservation information in the sidelink communication of FIG. 3A, consistent with some embodiments of the present disclosure. Referring to FIG. 3A and FIG. 3B, a sidelink communication system includes a UE 302, a UE 304, a UE 306, a UE 308, and a UE 310. For the sake of simplicity, FIG. 3A only shows the UE 302 and the UE 304. The UE 302 is a transmitter (Tx) UE (e.g., an omnidirectional Tx UE), and the UE 304 is a receiver (Rx) UE (e.g., an omnidirectional Rx UE) in the sidelink communication. UE 302 may reserve resources for data transmission. UE 302 may also encode the resource reservation information into an SCI and transmit the SCI, for example, along with a packet using one or more omnidirectional antennas. The SCI may include time and/or frequency resources for retransmissions scheduled at the UE 302, SPS time interval, and other information. Other UEs (the UE 306, the UE 308, and the UE 310 of FIG. 3B) in the sidelink communication system may receive the packet, decode the SCI received from the UE 302, and obtain the resource reservation information of the UE 302. Since the UE 306, the UE 308, and the UE 310 have resource reservation information of the UE 302, they may avoid using time and/or frequency resources reserved by the UE 302 when they perform resource selection or reselection. In this way, resource collision is avoided.

The resource reservation and resource selection mechanisms described above may be helpful for sidelink communications based on low frequency bands, for example, omnidirectional FR1 signals. In the present disclosure, FRI is defined as a frequency range of from 410 to 7125 MHz (including the sub-6 GHZ spectrum). But resource reservation and resource selection for sidelink communications based on high frequency bands (e.g., FR2) are more complicated. In the present disclosure, FR2 is defined as two frequency sub-ranges: FR2-1 from 24250 to 52600 MHz and FR2-2 from 52600 to 71000 MHZ (including the millimeter wave spectrum). For high frequency radio signals, which suffer from high propagation loss, beamforming with narrow beams is generally used to provide sufficient beamforming gain to compensate for the propagation loss.

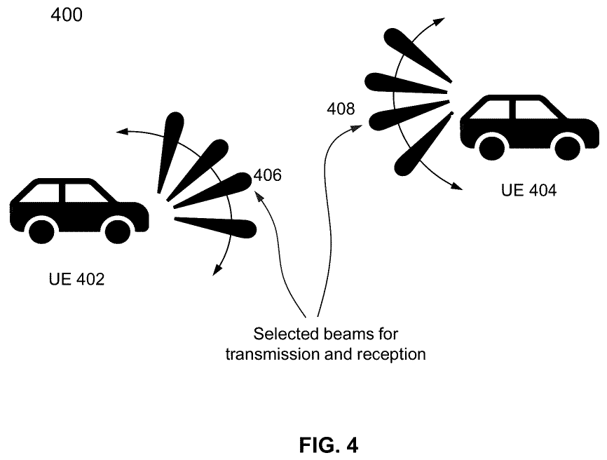

FIG. 4 is a schematic diagram illustrating a sidelink beamforming in a communication system, consistent with some embodiments of the present disclosure. Referring to FIG. 4, a communication system 400 includes a first UE (UE 402) and a second UE (UE 404) that communicate with each other via a sidelink communication using high frequency band signals (e.g., FR2). For example, the sidelink communication may be a V2X communication and both the UE 402 and the UE 404 are vehicles. The UE 402 may be a Tx UE and the UE 404 may be an Rx UE in the communication system 400. Since the sidelink communication between the UE 402 and the UE 404 uses high frequency signals, a sidelink beamforming is used so that a Tx beam 406 from UE 402 and a Rx beam 408 from UE 404 can be aligned. The term “beam alignment” and the term “beamforming” are used interchangeably in this disclosure. The above-noted resource reservation and resource selection mechanisms designed for low frequency bands (e.g., FR1) sidelink communication, may not be applicable to the resource reservation and resource selection in high frequency sidelink communications, especially when both UEs are moving. At least some embodiments of the present disclosure are directed to resource reservation and resource selection in sidelink communications based on high frequency bands, by considering the positions and Tx/Rx beam directions of Tx and Rx UEs.

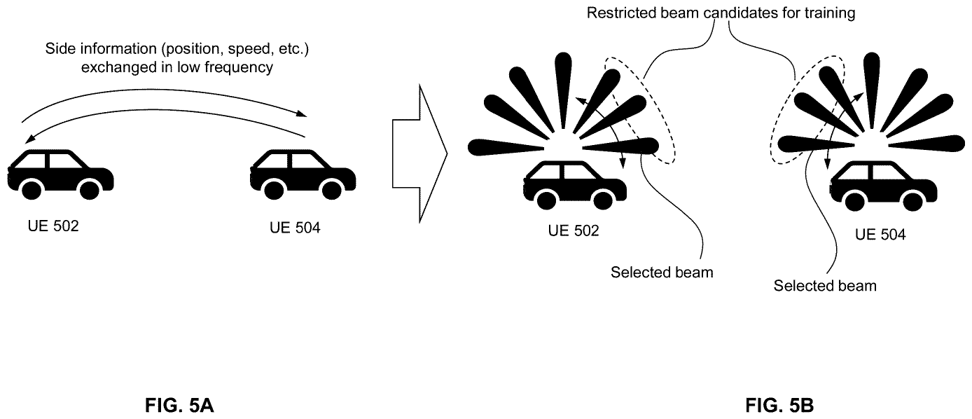

FIG. 5A is a schematic diagram illustrating side information exchange in a low frequency sidelink communication; and FIG. 5B is a schematic diagram illustrating a side information assisted beam alignment in the sidelink communication, consistent with some embodiments of the present disclosure. Referring to FIG. 5A and FIG. 5B, a communication system includes a first UE (UE 502) and a second UE (UE 504) that communicate with each other via sidelink communication. For example, the sidelink communication may be a V2X communication and both the UE 502 and the UE 504 are vehicles. The UE 502 may be a Tx UE and the UE 504 may be an Rx UE in the communication system. In some embodiments, as shown in FIG. 5A, the UE 502 and the UE 504 exchange side information using low frequency band signals (e.g., below 6 GHZ), for example, using omnidirectional antennas. The exchanged side information may include at least one of a current location, a speed, an acceleration, or a heading of a transmitting UE. The UE 502 and the UE 504 may exchange the side information periodically (e.g., every 100 ms). For example, the UE 502 and the UE 504 may exchange the side information by periodically broadcasting sidelink signals, such as cooperative awareness messages (CAMs) or basic safety messages (BSMs).

In some embodiments, after the side information exchange, for beam-based sidelink communications, the UE 502 and the UE 504 may perform beam alignment using a limited (restricted) number of candidate training pairs, for example, three beam pairs, as shown in FIG. 5B. The selected three beam pairs may cover a certain angular space, instead of the whole angular space, determined based on the exchanged CAM or BSM information. In this way, beam alignment overhead may be reduced.

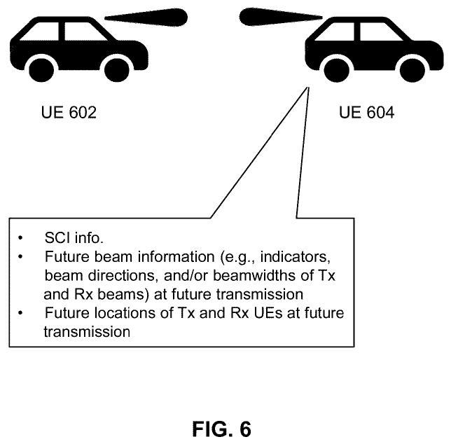

FIG. 6 is a schematic diagram illustrating resource reservation information for beam-based sidelink communication, consistent with some embodiments of the present disclosure. Referring to FIG. 6, a communication system includes a first UE (UE 602) and a second UE (UE 604) that communicate with each other via beam-based sidelink communication. The sidelink communication may be a V2X communication and both the UE 602 and the UE 604 are vehicles. The UE 604 may be a Tx UE and the UE 602 may be an Rx UE in the communication system. In some embodiments, the UE 604 transmits resource reservation information including future beam information (e.g., indicators, directions, and/or beamwidths of Tx beam and Rx beam) for future transmission, and/or estimated future location information of the UE 602 and/or the UE 604 for the expected future transmission. The UE 604 may transmit the resource reservation information over SCI. The UE 604 may obtain the future beam information (e. g., indicators, directions, and/or beamwidths of Tx and Rx beams) for future transmission, and the estimated future location information of the UE 602 and/or the UE 604, for example, based on previous communication with the UE 602. For example, the UE 604 may estimate a future location of the UE 602 by utilizing the information in the Society of Automotive Engineers (SAE) BSM and/or European Telecommunications Standards Institute (ETSI) CAM sent by the UE 602. The information in the BSM or the CAM may include at least one of a current location, a speed, an acceleration, or a future planned trajectory of the UE 602. Alternatively, or additionally, the UE 604 may estimate its future position at the time that future transmission occurs and send that information to the UE 602 at the PHY layer, MAC layer, or higher layer. The higher layer may include at least one of: the network layer, the transport layer, or the application layer.

The UE 604 may transmit the resource reservation information over an omnidirectional sidelink communication at a low frequency band (e.g., 5.9 GHZ), or over a beam-based sidelink communication at a high frequency band (e.g., mmWave bands) using a broad beam or beam sweeping to cover enough angular space. UE 604 may transmit the resource reservation information over SCI at PHY layer in order to facilitate other UEs to take into account the future beam and position information in a resource sensing procedure. Alternatively, or additionally, the UE 604 may transmit the resource reservation information using MAC CE at MAC layer, and/or a higher layer.

Based on this resource reservation information, other UEs (not shown in FIG. 6) in the communication system may avoid using reserved time and/or frequency resources, and Tx and/or Rx beams that may cause interference for the reserved transmission at the UE 604 and the UE 602. In this way, an improved spatial reuse and reliability in beam-based sidelink communications may be achieved.

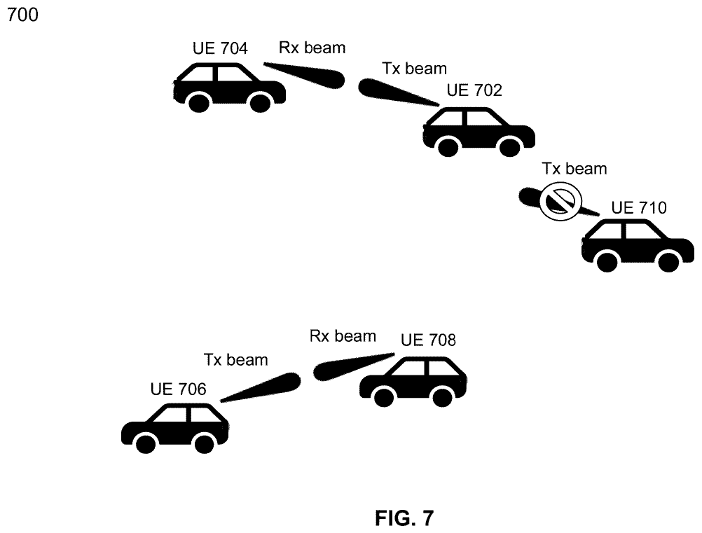

FIG. 7 is a schematic diagram illustrating an exemplary resource collision avoidance system 700, consistent with some embodiments of the present disclosure. Referring to FIG. 7, the communication system 700 includes a UE 702 (e.g., Tx UE) and a UE 704 (e.g., Rx UE) that communicate with each other via beam-based sidelink communication, and a UE 706 (e.g., Tx UE) and a UE 708 (Rx UE) that also communicate with each other via beam-based sidelink communication. The system 700 also includes other UEs such as a UE 710. As shown in FIG. 7, the direction of a Tx beam for the UE 710 is substantially the same as the direction of the Tx beam of the UE 702. Referring to FIG. 7, the UE 702 transmits information, such as the future beam information (e.g., indicators, directions, and/or beamwidths of Tx and Rx beams), estimated future locations of the UE 702 and/or UE 704. Based on the information, the UE 710 avoids using overlapping resources in Tx beam transmission as it may cause interference to the beam-based sidelink communication between the UE 702 and the UE 704. On the other hand, the Tx beam and the Rx beam direction of the UE 706 and the UE 708 are different from the Tx beam and the Rx beam direction of the UE 702 and the UE 704. Therefore, the UE 706 and the UE 708 are allowed to perform beam-based sidelink communication even using the resources overlapping with those of the UE 702 and the UE 704 since transmission/reception between the UE 706 and the UE 708 do not likely interfere with the communication between the UE 702 and the UE 704 because of different beam directions.

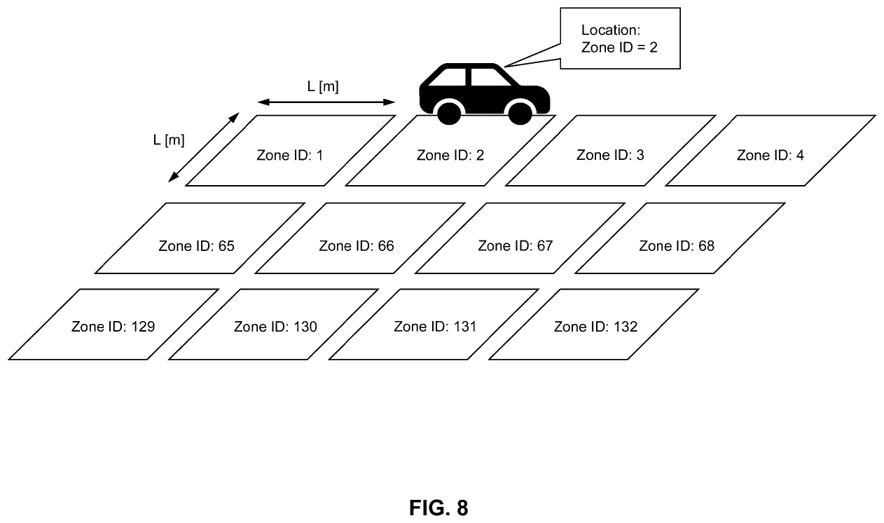

FIG. 8 is a schematic diagram illustrating a method for indicating an estimated future location of a UE, consistent with some embodiments of the present disclosure. In some embodiments, as shown in FIG. 8, multiple two-dimensional (2D) zones are configured. Each zone has a unique identification (ID) number (e.g., 1, 2, 3, 4, . . . 132). For example, a zone having ID of 1 is configured. Each dimension (e.g., width and length) L of the zones is also configured, for example, from 1, 5, 10, 20, 30, 40, 50 m (e.g., when each zone is 2-dimensional (2D) and has a substantially square shape). The zone dimension L can be any other number, for example, smaller than 1 m or larger than 50 m. In this way, an estimated future location of a UE is indicated using an ID of a zone at which the UE is expected to be located. In some embodiments, instead of the 2D zone, a 3D zone corresponding to 3D beamforming (i.e., horizontal and vertical beamforming) is also configured. In some embodiments, the expected future location is calculated using, for example, a simple estimation technique based on a current location, speed, and heading, assuming a constant speed and heading, or using more advanced estimation techniques considering vehicle dynamics. Alternatively, or additionally, the future location may be estimated and indicated by SAE BSM or ETSI CAM (e.g., a current position, speed, heading, future planned trajectory, etc.) at the application layer.

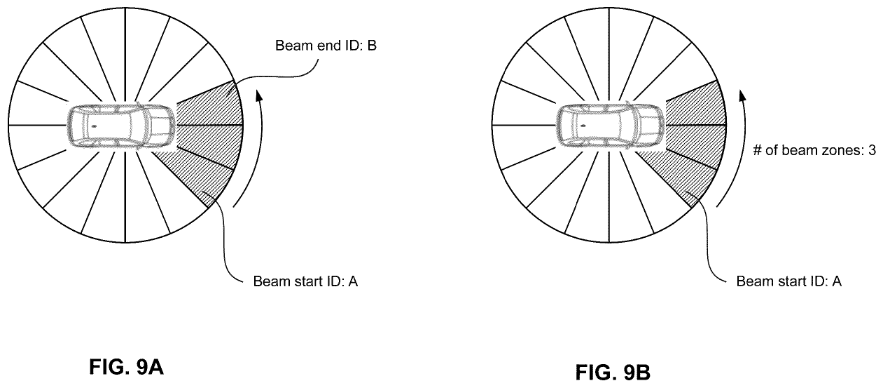

FIG. 9A is a schematic diagram illustrating a method for indicating an estimated future beam information, and FIG. 9B is a schematic diagram illustrating another method for indicating an estimated future beam information, consistent with some embodiments of the present disclosure. In some embodiments, beam information (beam direction and beamwidth) of an estimated future beam (Tx beam or Rx beam) is indicated using 2D azimuth beam information. For example, as shown in FIG. 9A and FIG. 9B, multiple beam zones are configured in a 2D polar coordinate system. The total number of beam zones may be configured by a network or pre-configured at a UE. In an embodiment, as shown in FIG. 9A, beam information (beam direction and beamwidth) of an estimated future beam is indicated using a beam start ID (A) and a beam end ID (B). In another embodiment, as shown in FIG. 9B, beam information (beam direction and beamwidth) of an estimated future beam is indicated using a beam start ID (A) and number of beam zones (e.g., 3).

In some embodiments, for a given beam (Tx beam or Rx beam), a corresponding beam zone may be selected based on some criteria, e.g., a beam ID that overlaps with the given beam for some beamwidth metric (e.g., half-power beamwidth). The reference point (or the origin) of the coordinate system and (x, y) direction may be specified. For example, as shown in FIG. 9A and FIG. 9B, the reference point can be set as the center of the 2D zone. In an embodiment, absolute (x, y) direction is used to indicate an estimated future beam direction. For example, x-direction and y-direction can be set to West and North, respectively. In another embodiment, a relative (x, y) direction is used. For example, x-direction and y-direction relative to the vehicle heading is used for indicating future beam direction. In some embodiments, instead of 2D polar coordinate, a 3D polar coordinate system is used to include vertical beam information, which is useful for 3D beamforming (e.g., horizontal and vertical beamforming). In some embodiments, the 2D (or 3D) azimuth beam information can be indexed with future time instances or time windows after which the shared beam information is valid. In some embodiments, when multiple beams are simultaneously transmitted in different directions, the overlap of the azimuth beam information associated with each of these beams may be sent. Otherwise, the information can identify the individual beams in the form of a bitmap. In this way, the future beam information (beam direction and beamwidth) is indicated with low overhead.

The methods described in this disclosure can be applied to any sidelink communications, for example, long-term evolution (LTE) or 5G new radio (NR) or a future generation (6th generation (6G), 7^{th} generation (7G), or any future generation) sidelink communications. The methods described in this disclosure can also be applied to downlink/uplink communications between a base station and a UE. The methods described in this disclosure can also be applied to other systems, for example, the systems that comply with other standards (e.g., IEEE standards).

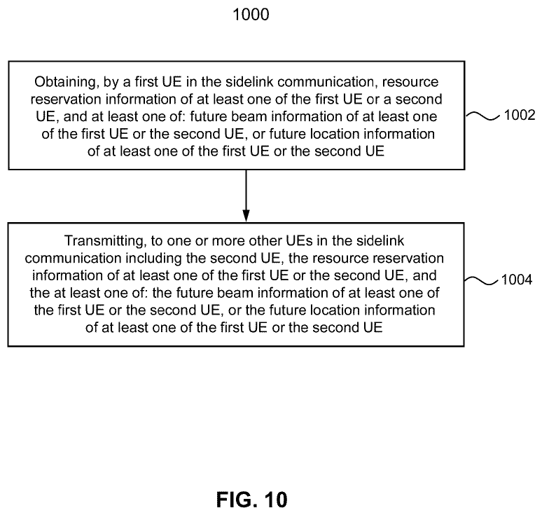

FIG. 10 is a flow chart illustrating a method 1000 for providing information for resource selection in a sidelink communication, consistent with some embodiments of the present disclosure. The method 1000 may be performed by a UE in a sidelink communication, such as the UE 604 of FIG. 6 or UE 702 of FIG. 7.

The method 1000 includes a step 1002 of obtaining, by a first UE in the sidelink communication, resource reservation information of at least one of the first UE or a second UE, and at least one of: future beam information of at least one of the first UE or the second UE, or future location information of at least one of the first UE or the second UE. For example, the first UE may be the UE 604 (FIG. 6) or the UE 702 (FIG. 7), and the second UE may be the UE 602 (FIG. 6) or the UE 704 (FIG. 7).

In some embodiments, the future beam information of the first UE may include information of at least one beam for a future transmission from the first UE, and the first UE may further determine one or more candidate beams for the future transmission from the first UE; and select the at least one beam from among the one or more candidate beams for the future transmission.

In some embodiments, the future beam information of at least one of the first UE or the second UE may include at least one of: a direction of a first beam, a width of a first beam, a beam indicator of a first beam, a transmission configuration indicator (TCI) state ID of a first beam, a reference signal resource indicator associated with a first beam, a quasi co-location (QCL) type of a first beam, a direction of a second beam, a width of a second beam, a beam indicator of a second beam, a TCI state ID of a second beam, a reference signal resource indicator associated with a second beam, or a QCL type of a second beam. The first beam may be used by the first UE for transmission at a first time later than a current time, and the second beam may be used by the second UE for reception at a second time later than the current time, the first time and the second time being the same or different. The first time and the second time may be configured by a network node, or pre-configured at the first UE and/or second UE. The QCL described in this disclosure may be consistent with the definition of QCL in the 3GPP specifications.

In some embodiments, the future location information of at least one of the first UE or the second UE may include at least one of: an estimated first location of the first UE at a first time later than a current time, or an estimated second location of the second UE at a second time later than the current time, the first time and the second time being the same or different. The first UE may further determine the estimated second location of the second UE at the second time based on a CAM or a BSM received from the second UE. The CAM or the BSM may include at least one of: a current location of the second UE, a speed of the second UE, a heading of the second UE, or a planned trajectory of the second UE.

In some embodiments, the first UE may further receive, from the second UE, the estimated second location of the second UE at the second time. The first UE may receive the estimated second location via physical layer information, MAC layer information, or higher layer information (e.g., the network layer, the transportation layer, or the application layer).

In some embodiments, the future location information of at least one of the first UE or the second UE may be indicated as an ID of a zone of a plurality of zones in two-dimension or three-dimension, for example, as shown in FIG. 8. The plurality of zones may be configured by a network node or pre-configured at the first UE.

In some embodiments, the future beam information of at least one of the first UE or the second UE may be indicated as one or more beam IDs corresponding to one or more beam zones of a plurality of beam zones in two-dimension or three-dimension, for example, as shown in FIG. 9A and FIG. 9B. The plurality of beam zones may be configured by a network node or pre-configured at the first UE. In an embodiment, the one or more beam IDs may include a beam start ID and a beam end ID, for example, as shown in FIG. 9A. In another embodiment, the one or more beam IDs may include a beam start ID and a number of the one or more beam zones, for example, as shown in FIG. 9B.

In some embodiments, the future beam information of at least one of the first UE or the second UE may be indicated as one or more coordinates in a two-dimensional polar coordinate system. In some embodiments, the future beam information of at least one of the first UE or the second UE may be indicated as one or more coordinates in a three-dimensional polar coordinate system.

The method 1000 includes a step 1004 of transmitting, to one or more other UEs in the sidelink communication including the second UE, the resource reservation information of at least one of the first UE or the second UE, and the at least one of: the future beam information of at least one of the first UE or the second UE, or the future location information of at least one of the first UE or the second UE. In an embodiment, for example, the one or more other UEs include a UE such as one or more of the UES 704, 706, 708, and 710 of FIG. 7.

In some embodiments, the first UE may transmit the resource reservation information of at least one of the first UE or a second UE, and at least one of: future beam information of at least one of the first UE or the second UE, or future location information of at least one of the first UE or the second UE over at least one of: a PSSCH, a PSCCH, or MAC CE, or a higher layer. The higher layer may include at least one of a network layer, a transport layer, or an application layer.

In some embodiments, the first UE may transmit the resource reservation information of at least one of the first UE or the second UE, and the at least one of: the future beam information of at least one of the first UE or the second UE, or the future location information of at least one of the first UE or the second UE, using a low frequency band (e.g., FR1).

In some embodiments, the first UE may transmit the resource reservation information of at least one of the first UE or the second UE, and the at least one of: the future beam information of at least one of the first UE or the second UE, or the future location information of at least one of the first UE or the second UE, using a high frequency band (e.g., FR2).

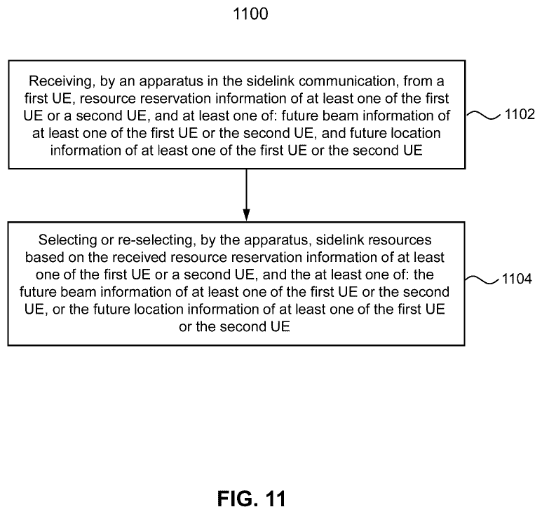

FIG. 11 is a flow chart illustrating a method 1100 for obtaining information for resource selection in a sidelink communication, consistent with some embodiments of the present disclosure. The method 1100 may be performed by a UE in a sidelink communication, such as the UE 602 of FIG. 6 or UE 704 of FIG. 7.

The method 1100 includes a step 1102 of receiving, by an apparatus in the sidelink communication, from a first UE, resource reservation information of at least one of the first UE or a second UE, and at least one of: future beam information of at least one of the first UE or the second UE, and future location information of at least one of the first UE or the second UE. For example, in an embodiment, the apparatus may be a UE, such as the one of the UEs 706, 708, and 710 of FIG. 7. The first UE may be the UE 604 (FIG. 6) or the UE 702 (FIG. 7), and the second UE may be the UE 602 (FIG. 6) or the UE 704 (FIG. 7). In some embodiments, the apparatus may include a plurality of UEs in the sidelink communication including the second UE (e.g., the 704, 706, 708, and 710 of FIG. 7). In other embodiments, the apparatus is the second UE (e.g., the UE 602 (FIG. 6) or the UE 704 (FIG. 7)).

In some embodiments, the resource reservation information of at least one of the first UE or a second UE, and at least one of: future beam information of at least one of the first UE or the second UE, or future location information of at least one of the first UE or the second UE are received over at least one of: a PSSCH, a PSCCH, or MAC CE, or a higher layer.

In some embodiments, the future beam information of at least one of the first UE or the second UE may include at least one of: a direction of a first beam, a width of a first beam, a beam indicator of a first beam, a TCI state ID of a first beam, a reference signal resource indicator associated with a first beam, a QCL type of a first beam, a direction of a second beam, a width of a second beam, a beam indicator of a second beam, a TCI state ID of a second beam, a reference signal resource indicator associated with a second beam, or a QCL type of a second beam. The first beam may be used by the first UE for transmission at a first time later than a current time, and the second beam may be used by the second UE for reception at a second time later than the current time, the first time and the second time being the same or different.

In some embodiments, the future location information of at least one of the first UE or the second UE may include at least one of: an estimated first location of the first UE at a first time later than a current time, or an estimated second location of the second UE at a second time later than the current time, the first time and the second time being the same or different.

In some embodiments, the estimated second location of the second UE may be determined by the first UE based on a CAM or a BSM received from the second UE. The CAM or the BSM may include at least one of: a current location of the second UE, a speed of the second UE, a heading of the second UE, or a planned trajectory of the second UE.

In some embodiments, the estimated second location of the second UE is received by the first UE from the second UE via physical layer, MAC layer, or higher layer information.

In some embodiments, the apparatus receives the resource reservation information of at least one of the first UE or the second UE, and the at least one of: the future beam information of at least one of the first UE or the second UE, or the future location information of at least one of the first UE or the second UE, using a low frequency band, such as using an FR1.

In some embodiments, the apparatus receives the resource reservation information of at least one of the first UE or the second UE, and the at least one of: the future beam information of at least one of the first UE or the second UE, or the future location information of at least one of the first UE or the second UE, using a high frequency band, such as using a millimeter wave frequency band or FR2.

In some embodiments, the future location information of at least one of the first UE or the second UE may be indicated as an ID of a zone of a plurality of zones in two-dimension or three-dimension. The plurality of zones may be configured by a network, or pre-configured at the first UE and/or second UE.

In some embodiments, the future beam information of at least one of the first UE or the second UE is indicated as one or more beam IDs corresponding to one or more beam zones of a plurality of beam zones in two-dimension or three-dimension. The plurality of beam zones may be configured by a network, or pre-configured at the first UE and/or second UE. In an embodiment, the one or more beam IDs may include a beam start ID and a beam end ID, for example, as shown in FIG. 9A. In another embodiment, the one or more beam IDs may include a beam start ID and a number of the one or more beam zones, for example, as shown in FIG. 9B.

In some embodiments, the future beam information of at least one of the first UE or the second UE may be indicated as one or more coordinates in a two-dimensional polar coordinate system. In some embodiments, the future beam information of at least one of the first UE or the second UE is indicated as one or more coordinates in a three-dimensional polar coordinate system.

In some embodiments, the estimated second location of the second UE may be received by the first UE from the second UE via a physical layer, a MAC layer, or higher layer information.

The method 1100 includes a step 1104 of selecting or re-selecting, by the apparatus, sidelink resources based on the received resource reservation information of at least one of the first UE or a second UE, and the at least one of: the future beam information of at least one of the first UE or the second UE, or the future location information of at least one of the first UE or the second UE.

In some embodiments, the apparatus is the second UE, and the future beam information of the second UE may include information of at least one beam for a future reception by the second UE. The apparatus may further determine one or more candidate beams for the future reception by the second UE; and select the at least one beam from among the one or more candidate beams for the future reception.

In some embodiments, the apparatus may identify one or more beams that are expected to cause interference to at least one of transmission from the first UE at the first time or reception by the second UE at the second time, based on at least one of: future beam information of at least one of the first UE or the second UE, or future location information of at least one of the first UE or the second UE. The apparatus may further identify one or more resources overlapping with one or more resources indicated in the resource reservation information of at least one of the first UE or the second UE; and exclude the overlapping one or more resources, using the identified one or more beams, from one or more candidate resources.

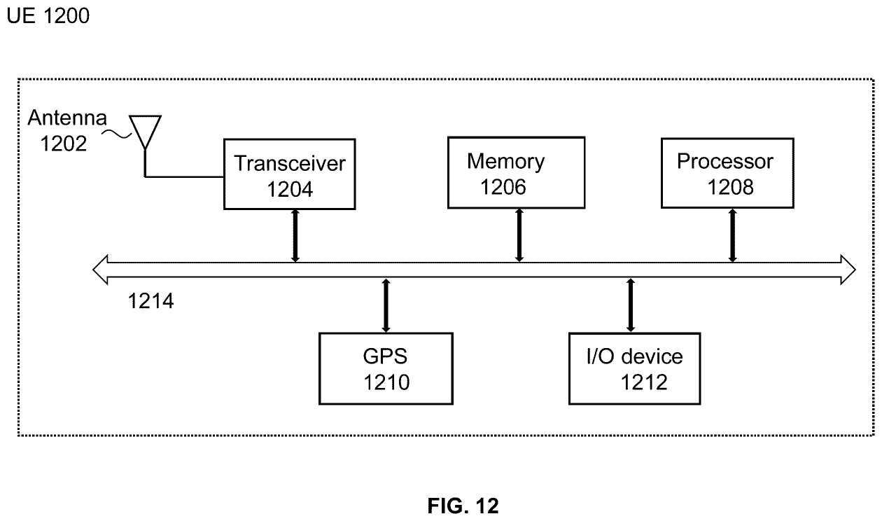

FIG. 12 is a block diagram of a UE 1200, consistent with some embodiments of the present disclosure. UE 1200 may be mounted in a moving vehicle or in a fixed position. UE 1200 may take any form, including but not limited to, a vehicle, a component mounted in a vehicle, a road-side unit, a laptop computer, a wireless terminal including a mobile phone, a wireless handheld device, or wireless personal device, or any other form. Referring to FIG. 12, the UE 1200 may include antenna 1202 that may be used for transmission or reception of electromagnetic signals to/from a base station or other UEs. The antenna 1202 may include one or more antenna elements and may enable different input-output antenna configurations, for example, multiple input multiple output (MIMO) configuration, multiple input single output (MISO) configuration, and single input multiple output (SIMO) configuration. In some embodiments, the antenna 1202 may include multiple (e.g., tens or hundreds) antenna elements and may enable multi-antenna functions such as beamforming. In some embodiments, the antenna 1202 is a single antenna. The antenna 1202 can be an FR1 antenna or an FR2 antenna.

The UE 1200 may include a transceiver 1204 that is coupled to the antenna 1202. The transceiver 1204 may be a wireless transceiver at the UE 1200 and may communicate bi-directionally with a base station or other UEs. For example, the transceiver 1204 may receive/transmit wireless signals from/to a base station via downlink/uplink communication. The transceiver 1204 may also receive/transmit wireless signals from/to another UE or road side unit via sidelink communication. The transceiver 1204 may include a modem to modulate the packets and provide the modulated packets to the antenna 1202 for transmission, and to demodulate packets received from the antenna 1202.

The UE 1200 may include a memory 1206. The memory 1206 may be any type of computer-readable storage medium including volatile or non-volatile memory devices, or a combination thereof. The computer-readable storage medium includes, but is not limited to, non-transitory computer storage media. A non-transitory storage medium may be accessed by a general purpose or special purpose computer. Examples of non-transitory storage medium include, but are not limited to, a portable computer diskette, a hard disk, random access memory (RAM), read-only memory (ROM), an erasable programmable read-only memory (EPROM), electrically erasable programmable ROM (EEPROM), a digital versatile disk (DVD), flash memory, compact disk (CD) ROM or other optical disk storage, magnetic disk storage or other magnetic storage devices, etc. A non-transitory medium may be used to carry or store desired program code means (e. g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable medium.

The memory 1206 may store information related to identities of UE 1200 and the signals and/or data received by antenna 1202. The memory 1206 may also store post-processing signals and/or data. The memory 1206 may also store computer-readable program instructions, mathematical models, and algorithms that are used in signal processing in transceiver 1204 and computations in processor 1208. The memory 1206 may further store computer-readable program instructions for execution by processor 1208 to operate UE 1200 to perform various functions described in this disclosure. In some examples, the memory 1206 may include a basic input/output system (BIOS) which may control basic hardware or software operation such as the interaction with peripheral components or devices. In some embodiments, the memory 1206 includes both LTE SL and NR SL modules. In some embodiments, the memory 1206 includes an NR SL module only. In some embodiments, the memory 1206 includes an LTE SL module only.

The computer-readable program instructions of the present disclosure may be assembler instructions, instruction-set-architecture (ISA) instructions, machine instructions, machine-dependent instructions, microcode, firmware instructions, state-setting data, or source code or object code written in any combination of one or more programming languages, including an object-oriented programming language, and conventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a local area network (LAN) or a wide area network (WAN).

The UE 1200 may include a processor 1208 that may include a hardware device with processing capabilities. The processor 1208 may include at least one of a general-purpose processor, a digital signal processor (DSP), a central processing unit (CPU), a microcontroller, an application specific integrated circuit (ASIC), a field programmable gate array (FPGA), a programmable logic device, a discrete gate or transistor logic component, a discrete hardware component, or other programmable logic device. Examples of the general-purpose processor include, but are not limited to, a microprocessor, any conventional processor, a controller, a microcontroller, or a state machine. In some embodiments, the processor 1208 may be implemented using a combination of devices (e.g., a combination of a DSP and a microprocessor, multiple microprocessors, one or more microprocessors in conjunction with a DSP core, or any other such configuration). The processor 1208 may receive, from transceiver 1204, downlink signals or sidelink signals and further process the signals. The processor 1208 may also receive, from transceiver 1204, data packets and further process the packets. In some embodiments, the processor 1208 may be configured to operate a memory using a memory controller. In some embodiments, a memory controller may be integrated into the processor 1208. The processor 1208 may be configured to execute computer-readable instructions stored in a memory (e.g., the memory 1206) to cause the UE 1200 to perform various functions.

The UE 1200 may include a global positioning system (GPS) 1210. The GPS 1210 may be used for enabling location-based services or other services based on a geographical position of the UE 1200 and/or synchronization among UEs. The GPS 1210 may receive global navigation satellite systems (GNSS) signals from a single satellite or a plurality of satellite signals via the antenna 1202 and provide a geographical position of the UE 1200 (e. g., coordinates of the UE 1200). In some embodiments, the GPS 1210 is omitted. In some embodiments, a timer is included.

The UE 1200 may include an input/output (I/O) device 1212 that may be used to communicate a result of signal processing and computation to a user or another device. The I/O device 1212 may include a user interface including a display and an input device to transmit a user command to processor 1208. The display may be configured to display a status of signal reception at the UE 1200, the data stored at memory 1206, a status of signal processing, and a result of computation, etc. The display may include, but is not limited to, a cathode ray tube (CRT), a liquid crystal display (LCD), a light-emitting diode (LED), a gas plasma display, a touch screen, or other image projection devices for displaying information to a user. The input device may be any type of computer hardware equipment used to receive data and control signals from a user. The input device may include, but is not limited to, a keyboard, a mouse, a scanner, a digital camera, a joystick, a trackball, cursor direction keys, a touchscreen monitor, or audio/video commanders, etc.

The UE 1200 may further include a machine interface 1214, such as an electrical bus that connects the transceiver 1204, the memory 1206, the processor 1208, the GPS 1210, and the I/O device 1212.

In some embodiments, the UE 1200 may be a first UE configured or programmed to provide information for resource selection in a sidelink communication. The processor 1208 may be configured to execute the instructions stored in the memory 1206 to obtain resource reservation information of at least one of the first UE or a second UE, and at least one of: future beam information of at least one of the first UE or the second UE, or future location information of at least one of the first UE or the second UE; and transmit, to one or more other UEs in the sidelink communication including the second UE, the resource reservation information of at least one of the first UE or the second UE, and the at least one of: the future beam information of at least one of the first UE or the second UE, or the future location information of at least one of the first UE or the second UE.

In some embodiments, the UE 1200 may be an apparatus configured or programmed to provide information for resource selection in a sidelink communication. The processor 1208 may be configured to execute the instructions stored in the memory 1206 to receive, from a first UE in the sidelink communication, resource reservation information of at least one of the first UE or a second UE, and at least one of: future beam information of at least one of the first UE or the second UE, or future location information of at least one of the first UE or the second UE; and select or re-select sidelink resources based on the received resource reservation information of at least one of the first UE or a second UE, and the at least one of: the future beam information of at least one of the first UE or the second UE, or the future location information of at least one of the first UE or the second UE.

As used in this disclosure, use of the term “or” in a list of items indicates an inclusive list. The list of items may be prefaced by a phrase such as “at least one of” or “one or more of.” For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification, the terms “comprise,” “include,” or “contain” may be used interchangeably and have the same meaning and are to be construed as inclusive and open-ended. The terms “comprise,” “include,” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

It will be further understood that various modifications, alternatives, and variations in the details, materials, and arrangements of the parts which have been described and illustrated in order to explain the nature of described embodiments may be made by those skilled in the art without departing from the scope. Accordingly, the following claims embrace all such alternatives, modifications, and variations that fall within the terms of the claims.

Clause 1. A first user equipment (UE) for providing information for resource selection in a sidelink communication, the first UE comprising:
a memory storing an instruction; and
a processor configured to execute the instruction stored in the memory to:
obtain resource reservation information of at least one of the first UE or a second UE, and at least one of: future beam information of at least one of the first UE or the second UE, or future location information of at least one of the first UE or the second UE; and
transmit, to one or more other UEs in the sidelink communication including the second UE, the resource reservation information of at least one of the first UE or the second UE, and the at least one of: the future beam information of at least one of the first UE or the second UE, or the future location information of at least one of the first UE or the second UE.

Clause 2. The first UE of clause 1, wherein the future beam information of the first UE comprises information of at least one beam for a future transmission from the first UE, and wherein the processor is further configured to execute the instruction stored in the memory to:
determine one or more candidate beams for the future transmission from the first UE; and
select the at least one beam from among the one or more candidate beams for the future transmission.

Clause 3. The first UE of clause 1, wherein the future beam information of at least one of the first UE or the second UE comprises at least one of: a direction of a first beam, a width of the first beam, a beam indicator of the first beam, a transmission configuration indicator (TCI) state ID of the first beam, a reference signal resource indicator associated with the first beam, a quasi co-location (QCL) type of the first beam, a direction of a second beam, a width of the second beam, a beam indicator of the second beam, a TCI state ID of the second beam, a reference signal resource indicator associated with the second beam, or a QCL type of the second beam, and
wherein the first beam is to be used by the first UE for transmission at a first time later than a current time, and the second beam is to be used by the second UE for reception at a second time later than the current time, the first time and the second time being the same or different.

Clause 4. The first UE of clause 1, wherein the future location information of at least one of the first UE or the second UE comprises at least one of: an estimated first location of the first UE at a first time later than a current time, or an estimated second location of the second UE at a second time later than the current time, the first time and the second time being the same or different.

Clause 5. The first UE of clause 4, wherein the processor is further configured to execute the instruction stored in the memory to:
determine the estimated second location of the second UE at the second time based on a cooperative awareness message (CAM) or a basic safety message (BSM) received from the second UE, and
wherein the CAM or the BSM comprises at least one of: a current location of the second UE, a speed of the second UE, a heading of the second UE, or a planned trajectory of the second UE.

Clause 6. The first UE of clause 4, wherein the processor is further configured to execute the instruction stored in the memory to:
receive, from the second UE, the estimated second location of the second UE at the second time,
wherein the estimated second location is received via physical layer information, media access control (MAC) layer information, or higher layer information.

Clause 7. The first UE of clause 1, wherein the processor is further configured to execute the instruction stored in the memory to:
transmit, to the one or more other UEs, using an FR1, the resource reservation information of at least one of the first UE or the second UE, and the at least one of: the future beam information of at least one of the first UE or the second UE, or the future location information of at least one of the first UE or the second UE.

Clause 8. The first UE of clause 1, wherein the processor is further configured to execute the instruction stored in the memory to:
transmit, to the one or more other UEs, using a millimeter wave frequency band, the resource reservation information of at least one of the first UE or the second UE, and the at least one of: the future beam information of at least one of the first UE or the second UE, or the future location information of at least one of the first UE or the second UE.

Clause 9. The first UE of clause 1, wherein the future location information of at least one of the first UE or the second UE is indicated as an identification (ID) of a zone of a plurality of zones in two-dimension or three-dimension, the plurality of zones being configured or pre-configured.

Clause 10. The first UE of clause 1, wherein the future beam information of at least one of the first UE or the second UE is indicated as one or more beam IDs corresponding to one or more beam zones of a plurality of beam zones in two-dimension or three-dimension, the plurality of beam zones being configured or pre-configured.

Clause 11. The first UE of clause 10, wherein the one or more beam IDs comprise a beam start ID and a beam end ID.

Clause 12. The first UE of clause 10, wherein the one or more beam IDs comprise a beam start ID and a number of the one or more beam zones.

Clause 13. The first UE of clause 1, wherein the future beam information of at least one of the first UE or the second UE is indicated as one or more coordinates in a two-dimensional polar coordinate system.

Clause 14. The first UE of clause 1, wherein the future beam information of at least one of the first UE or the second UE is indicated as one or more coordinates in a three-dimensional polar coordinate system.

Clause 15. The first UE of clause 1, wherein the resource reservation information of at least one of the first UE or a second UE, and at least one of: the future beam information of at least one of the first UE or the second UE, or the future location information of at least one of the first UE or the second UE are transmitted over at least one of: a physical sidelink shared channel (PSSCH), a physical sidelink control channel (PSCCH), a medium access control (MAC) control element (CE), or a higher layer.

Clause 16. An apparatus for obtaining information for resource selection in a sidelink communication, the apparatus comprising:
a memory storing an instruction; and
a processor configured to execute the instruction stored in the memory to:
receive, from a first user equipment (UE) in the sidelink communication, resource reservation information of at least one of the first UE or a second UE, and at least one of: future beam information of at least one of the first UE or the second UE, or future location information of at least one of the first UE or the second UE; and
select or re-select sidelink resources based on the received resource reservation information of at least one of the first UE or a second UE, and the at least one of: the future beam information of at least one of the first UE or the second UE, or the future location information of at least one of the first UE or the second UE.

Clause 17. The apparatus of clause 16, wherein the apparatus comprises a plurality of UEs in the sidelink communication including the second UE.

Clause 18. The apparatus of clause 16, wherein the apparatus is the second UE, and the future beam information of the second UE comprises information of at least one beam for a future reception by the second UE, and wherein the processor is further configured to execute the instruction stored in the memory to:
determine one or more candidate beams for the future reception by the second UE; and
select the at least one beam from among the one or more candidate beams for the future reception.

Clause 19. The apparatus of clause 16, wherein the future beam information of at least one of the first UE or the second UE comprises at least one of: a direction of a first beam, a width of the first beam, a beam indicator of the first beam, a transmission configuration indicator (TCI) state ID of the first beam, a reference signal resource indicator associated with the first beam, a quasi co-location (QCL) type of the first beam, a direction of a second beam, a width of the second beam, a beam indicator of the second beam, a TCI state ID of the second beam, a reference signal resource indicator associated with the second beam, or a QCL type of the second beam, and wherein the first beam is to be used by the first UE for transmission at a first time later than a current time, and the second beam is to be used by the second UE for reception at a second time later than the current time, the first time and the second time being the same or different.

Clause 20. The apparatus of clause 16, wherein the future location information of at least one of the first UE or the second UE comprises at least one of: an estimated first location of the first UE at a first time later than a current time, or an estimated second location of the second UE at a second time later than the current time, the first time and the second time being the same or different.

Clause 21. The apparatus of clause 19, wherein in selecting or re-selecting the sidelink resources, the processor is further configured to execute the instruction stored in the memory to:
identify one or more beams that are expected to cause interference to at least one of transmission from the first UE at the first time or reception by the second UE at the second time, based on at least one of: the future beam information of at least one of the first UE or the second UE, or the future location information of at least one of the first UE or the second UE;
identify one or more resources overlapping with one or more resources indicated in the resource reservation information of at least one of the first UE or a second UE; and exclude the overlapping one or more resources, using the identified one or more beams, from one or more candidate resources.

Clause 22. The apparatus of clause 20, wherein the estimated second location of the second UE is determined by the first UE based on a cooperative awareness message (CAM) or a basic safety message (BSM) received from the second UE, and
wherein the CAM or the BSM comprises at least one of: a current location of the second UE, a speed of the second UE, a heading of the second UE, or a planned trajectory of the second UE.

Clause 23. The apparatus of clause 20, wherein the estimated second location of the second UE is received by the first UE from the second UE via physical layer, media access control (MAC) layer, or higher layer information.

Clause 24. The apparatus of clause 16, wherein the processor is further configured to execute the instruction stored in the memory to:
receive, from the first UE, using an FR1, the resource reservation information of at least one of the first UE or the second UE, and the at least one of: the future beam information of at least one of the first UE or the second UE, or the future location information of at least one of the first UE or the second UE.

Clause 25. The apparatus of clause 16, wherein the processor is further configured to execute the instruction stored in the memory to:
receive, from the first UE, using a millimeter wave frequency band, the resource reservation information of at least one of the first UE or the second UE, and the at least one of: the future beam information of at least one of the first UE or the second UE, or the future location information of at least one of the first UE or the second UE.

Clause 26. The apparatus of clause 16, wherein the future location information of at least one of the first UE or the second UE is indicated as an identification (ID) of a zone of a plurality of zones in two-dimension or three-dimension, the plurality of zones being configured or pre-configured.

Clause 27. The apparatus of clause 16, wherein the future beam information of at least one of the first UE or the second UE is indicated as one or more beam IDs corresponding to one or more beam zones of a plurality of beam zones in two-dimension or three-dimension, the plurality of beam zones being configured or pre-configured.

Clause 28. The apparatus of clause 27, wherein the one or more beam IDs comprise a beam start ID and a beam end ID.

Clause 29. The apparatus of clause 27, wherein the one or more beam IDs comprise a beam start ID and a number of the one or more beam zones.

Clause 30. The apparatus of clause 16, wherein the future beam information of at least one of the first UE or the second UE is indicated as one or more coordinates in a two-dimensional polar coordinate system.

Clause 31. The apparatus of clause 16, wherein the future beam information of at least one of the first UE or the second UE is indicated as one or more coordinates in a three-dimensional polar coordinate system.

Clause 32. The apparatus of clause 16, wherein the resource reservation information of at least one of the first UE or a second UE, and at least one of: the future beam information of at least one of the first UE or the second UE, or the future location information of at least one of the first UE or the second UE are received over at least one of: a physical sidelink shared channel (PSSCH), a physical sidelink control channel (PSCCH), a medium access control (MAC) control element (CE), or a higher layer.

Clause 33. A method for providing information for resource selection in a sidelink communication, the method comprising:
obtaining, by a first user equipment (UE) in the sidelink communication, resource reservation information of at least one of the first UE or a second UE, and at least one of: future beam information of at least one of the first UE or the second UE, or future location information of at least one of the first UE or the second UE; and
transmitting, to one or more other UEs in the sidelink communication including the second UE, the resource reservation information of at least one of the first UE or the second UE, and the at least one of: the future beam information of at least one of the first UE or the second UE, or the future location information of at least one of the first UE or the second UE.

Clause 34. The method of clause 33, wherein the future beam information of the first UE comprises information of at least one beam for a future transmission from the first UE, and the method further comprises:
determining one or more candidate beams for the future transmission from the first UE; and
selecting the at least one beam from among the one or more candidate beams for the future transmission.

Clause 35. The method of clause 33, wherein the future beam information of at least one of the first UE or the second UE comprises at least one of: a direction of a first beam, a width of the first beam, a beam indicator of the first beam, a transmission configuration indicator (TCI) state ID of the first beam, a reference signal resource indicator associated with the first beam, a quasi co-location (QCL) type of the first beam, a direction of a second beam, a width of the second beam, a beam indicator of the second beam, a TCI state ID of the second beam, a reference signal resource indicator associated with the second beam, or a QCL type of the second beam, and
wherein the first beam is to be used by the first UE for transmission at a first time later than a current time, and the second beam is to be used by the second UE for reception at a second time later than the current time, the first time and the second time being the same or different.

Clause 36. The method of clause 33, wherein the future location information of at least one of the first UE or the second UE comprises at least one of: an estimated first location of the first UE at a first time later than a current time, or an estimated second location of the second UE at a second time later than the current time, the first time and the second time being the same or different.

Clause 37. The method of clause 36, further comprising: determining the estimated second location of the second UE at the second time based on a cooperative awareness message (CAM) or a basic safety message (BSM) received from the second UE,
wherein the CAM or the BSM comprises at least one of: a current location of the second UE, a speed of the second UE, a heading of the second UE, or a planned trajectory of the second UE.

Clause 38. The method of clause 36, further comprising: receiving, from the second UE, the estimated second location of the second UE at the second time, wherein the estimated second location is received via physical layer information, media access control (MAC) layer information, or higher layer information.

Clause 39. The method of clause 33, further comprising: transmitting, to the one or more other UEs, using an FR1, the resource reservation information of at least one of the first UE or the second UE, and the at least one of: the future beam information of at least one of the first UE or the second UE, or the future location information of at least one of the first UE or the second UE.

Clause 40. The method of clause 33, further comprising: transmitting, to the one or more other UEs, using a millimeter wave frequency band, the resource reservation information of at least one of the first UE or the second UE, and the at least one of: the future beam information of at least one of the first UE or the second UE, or the future location information of at least one of the first UE or the second UE.

Clause 41. The method of clause 33, wherein the future location information of at least one of the first UE or the second UE is indicated as an identification (ID) of a zone of a plurality of zones in two-dimension or three-dimension, the plurality of zones being configured or pre-configured.

Clause 42. The method of clause 33, wherein the future beam information of at least one of the first UE or the second UE is indicated as one or more beam IDs corresponding to one or more beam zones of a plurality of beam zones in two-dimension or three-dimension, the plurality of beam zones being configured or pre-configured.

Clause 43. The method of clause 42, wherein the one or more beam IDs comprise a beam start ID and a beam end ID.

Clause 44. The method of clause 42, wherein the one or more beam IDs comprise a beam start ID and a number of the one or more beam zones.

Clause 45. The method of clause 33, wherein the future beam information of at least one of the first UE or the second UE is indicated as one or more coordinates in a two-dimensional polar coordinate system.

Clause 46. The method of clause 33, wherein the future beam information of at least one of the first UE or the second UE is indicated as one or more coordinates in a three-dimensional polar coordinate system.

Clause 47. The method of clause 33, wherein the resource reservation information of at least one of the first UE or a second UE, and at least one of: the future beam information of at least one of the first UE or the second UE, or the future location information of at least one of the first UE or the second UE are transmitted over at least one of: a physical sidelink shared channel (PSSCH), a physical sidelink control channel (PSCCH), a medium access control (MAC) control element (CE), or a higher layer.

Clause 48. A method for obtaining information for resource selection in a sidelink communication, the method comprising:
receiving, by an apparatus in the sidelink communication, from a first user equipment (UE), resource reservation information of at least one of the first UE or a second UE, and at least one of: future beam information of at least one of the first UE or the second UE, and future location information of at least one of the first UE or the second UE; and
selecting or re-selecting, by the apparatus, sidelink resources based on the received resource reservation information of at least one of the first UE or a second UE, and the at least one of: the future beam information of at least one of the first UE or the second UE, or the future location information of at least one of the first UE or the second UE.

Clause 49. The method of clause 48, wherein the apparatus comprises a plurality of UEs in the sidelink communication including the second UE.

Clause 50. The method of clause 48, wherein the apparatus is the second UE, and the future beam information of the second UE comprises information of at least one beam for a future reception by the second UE, and the method further comprises:
determining one or more candidate beams for the future reception by the second UE; and
selecting the at least one beam from among the one or more candidate beams for the future reception.

Clause 51. The method of clause 48, wherein the future beam information of at least one of the first UE or the second UE comprises at least one of: a direction of a first beam, a width of the first beam, a beam indicator of the first beam, a transmission configuration indicator (TCI) state ID of the first beam, a reference signal resource indicator associated with the first beam, a quasi co-location (QCL) type of the first beam, a direction of a second beam, a width of the second beam, a beam indicator of the second beam, a TCI state ID of the second beam, a reference signal resource indicator associated with the second beam, or a QCL type of the second beam, and
wherein the first beam is to be used by the first UE for transmission at a first time later than a current time, and the second beam is to be used by the second UE for reception at a second time later than the current time, the first time and the second time being the same or different.

Clause 52. The method of clause 48, wherein the future location information of at least one of the first UE or the second UE comprises at least one of: an estimated first location of the first UE at a first time later than a current time, or an estimated second location of the second UE at a second time later than the current time, the first time and the second time being the same or different.

Clause 53. The method of clause 51, wherein selecting or re-selecting the sidelink resources further comprises: identifying one or more beams that are expected to cause interference to at least one of transmission from the first UE at the first time or reception by the second UE at the second time, based on at least one of: the future beam information of at least one of the first UE or the second UE, or the future location information of at least one of the first UE or the second UE;
identifying one or more resources overlapping with one or more resources indicated in the resource reservation information of at least one of the first UE or a second UE; and
excluding the overlapping one or more resources, using the identified one or more beams, from one or more candidate resources.

Clause 54. The method of clause 52, wherein the estimated second location of the second UE is determined by the first UE based on a cooperative awareness message (CAM) or a basic safety message (BSM) received from the second UE, and wherein the CAM or the BSM comprises at least one of: a current location of the second UE, a speed of the second UE, a heading of the second UE, or a planned trajectory of the second UE.

Clause 55. The method of clause 52, wherein the estimated second location of the second UE is received by the first UE from the second UE via physical layer, media access control (MAC) layer, or higher layer information.

Clause 56. The method of clause 48, further comprising: receiving, from the first UE, using an FR1, the resource reservation information of at least one of the first UE or the second UE, and the at least one of: the future beam information of at least one of the first UE or the second UE, or the future location information of at least one of the first UE or the second UE.

Clause 57. The method of clause 48, further comprising: receiving, from the first UE, using a millimeter wave frequency band, the resource reservation information of at least one of the first UE or the second UE, and the at least one of: the future beam information of at least one of the first UE or the second UE, or the future location information of at least one of the first UE or the second UE.

Clause 58. The method of clause 48, wherein the future location information of at least one of the first UE or the second UE is indicated as an identification (ID) of a zone of a plurality of zones in two-dimension or three-dimension, the plurality of zones being configured or pre-configured.

Clause 59. The method of clause 48, wherein the future beam information of at least one of the first UE or the second UE is indicated as one or more beam IDs corresponding to one or more beam zones of a plurality of beam zones in two-dimension or three-dimension, the plurality of beam zones being configured or pre-configured.

Clause 60. The method of clause 59, wherein the one or more beam IDs comprise a beam start ID and a beam end ID.

Clause 61. The method of clause 59, wherein the one or more beam IDs comprise a beam start ID and a number of the one or more beam zones.

Clause 62. The method of clause 48, wherein the future beam information of at least one of the first UE or the second UE is indicated as one or more coordinates in a two-dimensional polar coordinate system.

Clause 63. The method of clause 48, wherein the future beam information of at least one of the first UE or the second UE is indicated as one or more coordinates in a three-dimensional polar coordinate system.

Clause 64. The method of clause 48, wherein the resource reservation information of at least one of the first UE or a second UE, and at least one of: the future beam information of at least one of the first UE or the second UE, or the future location information of at least one of the first UE or the second UE are received over at least one of: a physical sidelink shared channel (PSSCH), a physical sidelink control channel (PSCCH), a medium access control (MAC) control element (CE), or a higher layer.

Clause 65. A non-transitory computer-readable medium storing instructions that are executable by one or more processors of a first user equipment (UE) in a sidelink communication network, to perform a method, the method comprising:
obtaining resource reservation information of at least one of the first UE or a second UE, and at least one of: future beam information of at least one of the first UE or the second UE, or future location information of at least one of the first UE or the second UE; and
transmitting, to one or more other UEs in the sidelink communication including the second UE, the resource reservation information of at least one of the first UE or the second UE, and the at least one of: the future beam information of at least one of the first UE or the second UE, or the future location information of at least one of the first UE or the second UE.

Clause 66. A non-transitory computer-readable medium storing instructions that are executable by one or more processors of an apparatus in a sidelink communication, to perform a method, the method comprising:
receiving, from a first user equipment (UE) in the sidelink communication, resource reservation information of at least one of the first UE or a second UE, and at least one of: future beam information of at least one of the first UE or the second UE, or future location information of at least one of the first UE or the second UE; and
selecting or re-selecting sidelink resources based on the received resource reservation information of at least one of the first UE or a second UE, and the at least one of: the future beam information of at least one of the first UE or the second UE, or the future location information of at least one of the first UE or the second UE.

1. A first user equipment (UE) for providing information for resource selection in a sidelink communication, the first UE comprising:
a memory storing an instruction; and
a processor configured to execute the instruction stored in the memory to:
obtain resource reservation information of at least one of the first UE or a second UE, and at least one of: future beam information of at least one of the first UE or the second UE, or future location information of at least one of the first UE or the second UE; and
transmit, to one or more other UEs in the sidelink communication including the second UE, the resource reservation information of at least one of the first UE or the second UE, and the at least one of: the future beam information of at least one of the first UE or the second UE, or the future location information of at least one of the first UE or the second UE.

2. The first UE of claim 1, wherein the future beam information of the first UE comprises information of at least one beam for a future transmission from the first UE, and wherein the processor is further configured to execute the instruction stored in the memory to:
determine one or more candidate beams for the future transmission from the first UE; and
select the at least one beam from among the one or more candidate beams for the future transmission.

3. The first UE of claim 1, wherein the future beam information of at least one of the first UE or the second UE comprises at least one of: a direction of a first beam, a width of the first beam, a beam indicator of the first beam, a transmission configuration indicator (TCI) state ID of the first beam, a reference signal resource indicator associated with the first beam, a quasi co-location (QCL) type of the first beam, a direction of a second beam, a width of the second beam, a beam indicator of the second beam, a TCI state ID of the second beam, a reference signal resource indicator associated with the second beam, or a QCL type of the second beam, and
wherein the first beam is to be used by the first UE for transmission at a first time later than a current time, and the second beam is to be used by the second UE for reception at a second time later than the current time, the first time and the second time being the same or different.

4. The first UE of claim 1, wherein the future location information of at least one of the first UE or the second UE comprises at least one of: an estimated first location of the first UE at a first time later than a current time, or an estimated second location of the second UE at a second time later than the current time, the first time and the second time being the same or different.

5. The first UE of claim 4, wherein the processor is further configured to execute the instruction stored in the memory to:
determine the estimated second location of the second UE at the second time based on a cooperative awareness message (CAM) or a basic safety message (BSM) received from the second UE, and
wherein the CAM or the BSM comprises at least one of: a current location of the second UE, a speed of the second UE, a heading of the second UE, or a planned trajectory of the second UE.

6. The first UE of claim 4, wherein the processor is further configured to execute the instruction stored in the memory to:
receive, from the second UE, the estimated second location of the second UE at the second time,
wherein the estimated second location is received via physical layer information, media access control (MAC) layer information, or higher layer information.

7. The first UE of claim 1, wherein the processor is further configured to execute the instruction stored in the memory to:
transmit, to the one or more other UEs, using an FR1, the resource reservation information of at least one of the first UE or the second UE, and the at least one of: the future beam information of at least one of the first UE or the second UE, or the future location information of at least one of the first UE or the second UE.

8. The first UE of claim 1, wherein the processor is further configured to execute the instruction stored in the memory to:
transmit, to the one or more other UEs, using a millimeter wave frequency band, the resource reservation information of at least one of the first UE or the second UE, and the at least one of: the future beam information of at least one of the first UE or the second UE, or the future location information of at least one of the first UE or the second UE.

9. The first UE of claim 1, wherein the future location information of at least one of the first UE or the second UE is indicated as an identification (ID) of a zone of a plurality of zones in two-dimension or three-dimension, the plurality of zones being configured or pre-configured.

10. The first UE of claim 1, wherein the future beam information of at least one of the first UE or the second UE is indicated as one or more beam IDs corresponding to one or more beam zones of a plurality of beam zones in two-dimension or three-dimension, the plurality of beam zones being configured or pre-configured.

11. The first UE of claim 10, wherein the one or more beam IDs comprise a beam start ID and a beam end ID.

12. The first UE of claim 10, wherein the one or more beam IDs comprise a beam start ID and a number of the one or more beam zones.

13. The first UE of claim 1, wherein the future beam information of at least one of the first UE or the second UE is indicated as one or more coordinates in a two-dimensional polar coordinate system.

14. The first UE of claim 1, wherein the future beam information of at least one of the first UE or the second UE is indicated as one or more coordinates in a three-dimensional polar coordinate system.

15. The first UE of claim 1, wherein the resource reservation information of at least one of the first UE or the second UE, and at least one of: the future beam information of at least one of the first UE or the second UE, or the future location information of at least one of the first UE or the second UE are transmitted over at least one of: a physical sidelink shared channel (PSSCH), a physical sidelink control channel (PSCCH), a medium access control (MAC) control element (CE), or a higher layer.

16. An apparatus for obtaining information for resource selection in a sidelink communication, the apparatus comprising:
a memory storing an instruction; and
a processor configured to execute the instruction stored in the memory to:
receive, from a first user equipment (UE) in the sidelink communication, resource reservation information of at least one of the first UE or the second UE, and at least one of: future beam information of at least one of the first UE or the second UE, or future location information of at least one of the first UE or the second UE; and
select or re-select sidelink resources based on the received resource reservation information of at least one of the first UE or a second UE, and the at least one of: the future beam information of at least one of the first UE or the second UE, or the future location information of at least one of the first UE or the second UE.

17. The apparatus of claim 16, wherein the apparatus comprises a plurality of UEs in the sidelink communication including the second UE.

18. The apparatus of claim 16, wherein the apparatus is the second UE, and the future beam information of the second UE comprises information of at least one beam for a future reception by the second UE, and wherein the processor is further configured to execute the instruction stored in the memory to:
determine one or more candidate beams for the future reception by the second UE; and
select the at least one beam from among the one or more candidate beams for the future reception.

19. The apparatus of claim 16, wherein the future beam information of at least one of the first UE or the second UE comprises at least one of: a direction of a first beam, a width of the first beam, a beam indicator of the first beam, a transmission configuration indicator (TCI) state ID of the first beam, a reference signal resource indicator associated with the first beam, a quasi co-location (QCL) type of the first beam, a direction of a second beam, a width of the second beam, a beam indicator of the second beam, a TCI state ID of the second beam, a reference signal resource indicator associated with the second beam, or a QCL type of the second beam, and
wherein the first beam is to be used by the first UE for transmission at a first time later than a current time, and the second beam is to be used by the second UE for reception at a second time later than the current time, the first time and the second time being the same or different.

20. A method for providing information for resource selection in a sidelink communication, the method comprising:
obtaining, by a first user equipment (UE) in the sidelink communication, resource reservation information of at least one of the first UE or a second UE, and at least one of: future beam information of at least one of the first UE or the second UE, or future location information of at least one of the first UE or the second UE; and
transmitting, to one or more other UEs in the sidelink communication including the second UE, the resource reservation information of at least one of the first UE or the second UE, and the at least one of: the future beam information of at least one of the first UE or the second UE, or the future location information of at least one of the first UE or the second UE.
